(19) United States
(12) Patent Application Publication
(10) Pub. No.: US 2006/0017703 A1
(43) Pub. Date: Jan. 26, 2006

(54) Input apparatus

(75) Inventors: Junichi Akama, Shinagawa (JP); Shinichiro Akieda, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU COMPONENT LIMITED, Tokyo (JP)

(21) Appl. No.: 10/991,872

(22) Filed: Nov. 19, 2004

(30) Foreign Application Priority Data
Jul. 23, 2004 (JP) 2004-216104

(51) Int. Cl. G09G 5/00

(52) U.S. Cl. 345/173

(57) ABSTRACT

An input apparatus includes a touch panel upper member for outputting a detection signal corresponding to an input position at which an input operation is executed, a moveable lower member disposed with respect to the touch panel upper member, an operation unit for executing the input operation, and an operation mechanism which, in accordance with the input operation of the operation unit, is operable to urge the moveable lower member into contact with the touch panel upper member at the input position to thereby transmit the input position to the touch panel upper member and output the detection signal corresponding to the input position.

### BACKGROUND OF THE INVENTION

1. Field of the Invention

The present invention generally relates to an input apparatus, and more particularly to an input apparatus for input by operating an operation unit.

2. Description of the Related Art

A conventional input apparatus, which is operated with an operation unit such as an operation lever, includes a magneto-electric transducer such as a permanent magnet and a Hall element. Here, the permanent magnet is mechanically mounted in an oscillatable manner on the magneto-electric transducer.

As a conventional example of a thin-sized coordinate inputting apparatus, there is a touch panel. As shown in Japanese Laid-Open Patent Application No. 61-259324, the touch panel has a pair of resistance sheets having a predetermined space therebetween, in which a contact position is detected by applying a voltage on one of the resistance sheets and measuring the electric potential of the other resistance sheet.

However, as described above, since the conventional input apparatus, which is operated with an operation unit such as an operation lever, has a structure where the permanent magnet is mechanically mounted in an oscillatable manner on the magneto-electric transducer, it is difficult to form the conventional input apparatus, for example, into a thin size.

Although the touch panel can be formed into a thin-size, the touch panel has a structure that is unsuitable for input using an operation unit such as an operation lever since the touch panel is designed for direct input with use of a finger or a pen.

### SUMMARY OF THE INVENTION

It is a general object of the present invention to provide an input apparatus that substantially obviates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by an input apparatus particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides an input apparatus including: a touch panel upper member for outputting a detection signal corresponding to an input position at which an input operation is executed; a moveable lower member disposed with respect to the touch panel upper member; an operation unit for executing the input operation; and an operation mechanism which, in accordance with the input operation of the operation unit, is operable to urge the moveable lower member into contact with the touch panel upper member at the input position to thereby transmit the input position to the touch panel upper member and output the detection signal corresponding to the input position.

In an input apparatus according to an embodiment of the present invention, the moveable lower member may include a flexible sheet lower member, and wherein the flexible sheet lower member is spaced from the touch panel upper member.

In an input apparatus according to an embodiment of the present invention, the operation mechanism may include a head part, and wherein the head part and the flexible sheet lower member may be disposed at opposite sides of the touch panel upper member.

In an input apparatus according to an embodiment of the present invention, the operation mechanism may be operable to urge the head part and the flexible sheet lower member towards one another to thereby urge the flexible sheet lower member into contact with the touch panel upper member.

In an input apparatus according to an embodiment of the present invention, the urging may be by magnetic attraction forces between the head part and the flexible sheet lower member.

In an input apparatus according to an embodiment of the present invention, the head part may be magnetized.

In an input apparatus according to an embodiment of the present invention, the head part may be disposed between the operation unit and the touch panel upper member.

In an input apparatus according to an embodiment of the present invention, the head part may be moveable by the operation unit along the touch panel upper member.

In an input apparatus according to an embodiment of the present invention, the input apparatus may further include a moving mechanism for oscillatably guiding the operation unit along a surface of the touch panel upper member.

In an input apparatus according to an embodiment of the present invention, the moving mechanism may be detachably attached to the touch panel upper member.

In an input apparatus according to an embodiment of the present invention, the head part may have a bottom face formed as a round shape.

In an input apparatus according to another embodiment of the present invention, the touch panel upper member and the flexible sheet lower member may form a touch panel unit, and wherein the operation mechanism may include a head part and a moveable bending member disposed at opposite sides of the touch panel unit.

In an input apparatus according to another embodiment of the present invention, the operation mechanism may be operable to urge the head part and moveable bending member towards one another to thereby draw the flexible sheet lower member into contact with the touch panel upper member.

In an input apparatus according to another embodiment of the present invention, the urging may be by magnetic attraction forces between the head part and the moveable bending member.

In an input apparatus according to another embodiment of the present invention, the movable bending member may be spherical in shape.

In an input apparatus according to another embodiment of the present invention, the head part may be magnetized.

In an input apparatus according to another embodiment of the present invention, the head part may be disposed between the operation unit and the touch panel upper member.

In an input apparatus according to another embodiment of the present invention, the head part may be moveable by the operation unit along the touch panel upper member.

In an input apparatus according to another embodiment of the present invention, the input apparatus may further include a moving mechanism for oscillatably guiding the operation unit along a surface of the touch panel upper member.

In an input apparatus according to another embodiment of the present invention, the moving mechanism may be detachably attached to the touch panel upper member.

In an input apparatus according to another embodiment of the present invention, the head part may have a bottom face formed as a round shape.

In an input apparatus according to another embodiment of the present invention, the input apparatus may further include a base plate having a recess part on which the moveable bending member is disposed.

In an input apparatus according to an embodiment of the present invention, the touch panel upper member and the moveable lower member may form a resistance film touch panel.

In an input apparatus according to an embodiment of the present invention, the touch panel upper member may include an optical touch panel.

Other objects and further features of the present invention will be apparent from the following detailed description when read in conjunction with the accompanying drawings.

### BRIEF DESCRIPTION OF THE DRAWINGS

FIG. 1 is a schematic diagram showing an exemplary configuration of a system according to a first embodiment of the present invention;

FIG. 2 is an exploded perspective diagram showing an input apparatus according to the first embodiment of the present invention;

FIG. 3 is a cross-sectional diagram showing an input apparatus according to the first embodiment of the present invention;

FIG. 4 is an exploded perspective diagram showing a touch panel according to the first embodiment of the present invention;

FIG. 5 is a flowchart showing a detection process of a CPU according to the first embodiment of the present invention;

FIG. 6 is an exploded perspective diagram showing an input apparatus according to a second embodiment of the present invention;

FIG. 7 is a cross-sectional diagram showing an input apparatus according to the second embodiment of the present invention;

FIG. 8 is an exploded perspective diagram showing an input apparatus according to a third embodiment of the present invention;

FIG. 9 is a cross-sectional diagram showing an input apparatus according to the third embodiment of the present invention;

FIG. 10 is an exploded perspective diagram showing an input apparatus according to a fourth embodiment of the present invention;

FIG. 11 is a cross-sectional diagram showing an input apparatus according to the fourth embodiment of the present invention;

FIG. 12 is an exploded perspective diagram showing an input apparatus according to a fifth embodiment of the present invention; and

FIG. 13 is a cross-sectional diagram showing an input apparatus according to the fifth embodiment of the present invention.

### DESCRIPTION OF THE PREFERRED EMBODIMENTS

In the following, embodiments of the present invention will be described with reference to the accompanying drawings.

[Information Processing System 1]

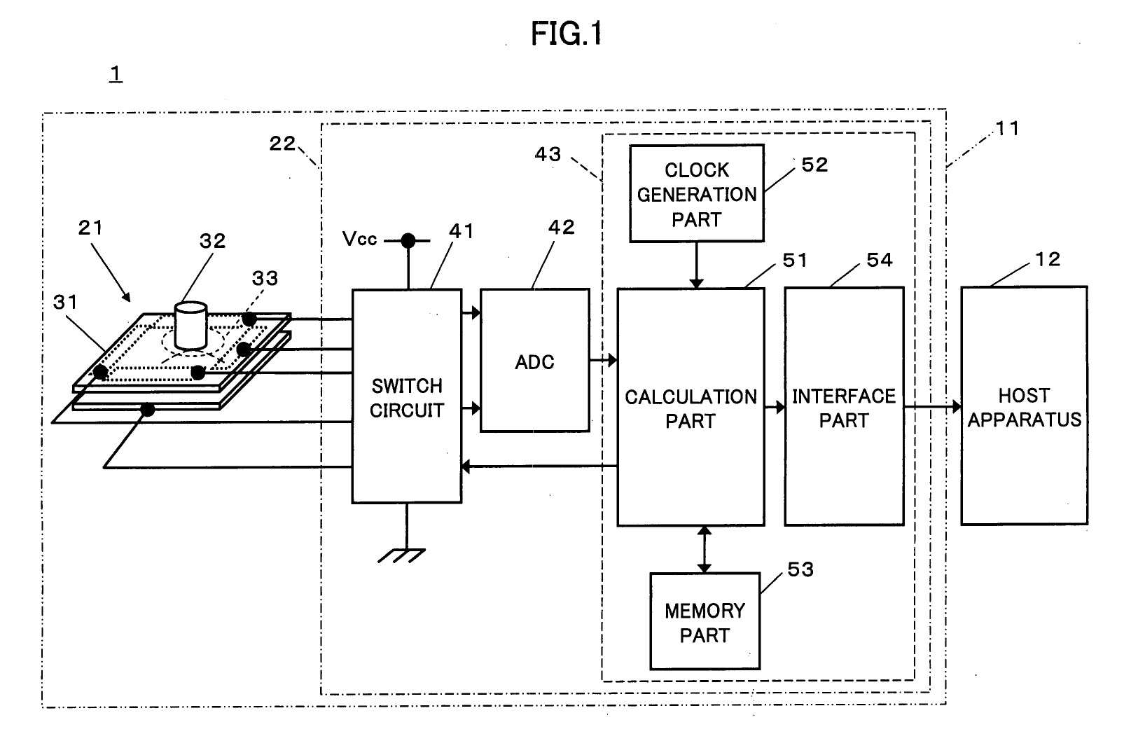

FIG. 1 is a diagram showing an exemplary structure of a system according to an embodiment of the present invention.

In this embodiment of the present invention, an information processing system 1 (e.g. game device or a personal computer) using an input system 11 is described.

The information processing system 1 includes the input system 11 and a host apparatus 12.

The input system 11 generates input information in accordance with input operations (maneuvers) of an operation unit 32 (e.g. operation lever) of an input apparatus 21, and sends the input information to the host apparatus 12. The host apparatus 12, in accordance with the input information sent from the input system 11, executes a process of moving, for example, a pointer or a cursor displayed on a display apparatus.

[Input System 11]

The input system 11 includes the input apparatus 21 and a circuit board (printed circuit board) 22.

The input apparatus 21 includes a touch panel 31 for outputting a detection signal(s) corresponding to an operation location of an operation face, the operation unit 32 for executing an input operation(s), and an operation mechanism 33 for transmitting the input operation of the operation unit 32 to a touch panel 31. The touch panel 31, employing, for example, a resistance film type touch panel, outputs a detection signal(s) corresponding to the input operation of the operation unit 32 and sends the detection signal(s) to the circuit board 22. It is to be noted that the structure of the input apparatus 21 is described in more detail below.

A switch circuit 41, an analog/digital converter (ADC) 42, and a CPU 43 are mounted on the circuit board 22.

The switch circuit 41 switches voltage applied to an electrode provided to the touch panel 31 in accordance with an instruction(s) from the CPU 43.

The analog/digital converter 42 converts a detected signal selected by the switch circuit 41 into digital data. The digital data converted in the analog/digital converter 42 is supplied to the CPU 43.

The CPU 43 includes a calculation part 51, a clock generation part 52, a memory part 53, and an interface (I/F) part. The calculation part 51 performs a process of generating input information based on the data provided from the analog/digital converter 42 by using a program stored in the memory part 53. Here, the calculation part 51 performs this process based on a clock(s) from the clock generation part 52. The input information generated in the calculation part 51 is provided to the interface part 54. The interface part 54, which serves as an interface with respect to the host apparatus 12, provides the input information to the host apparatus 12.

[Input Apparatus 21]

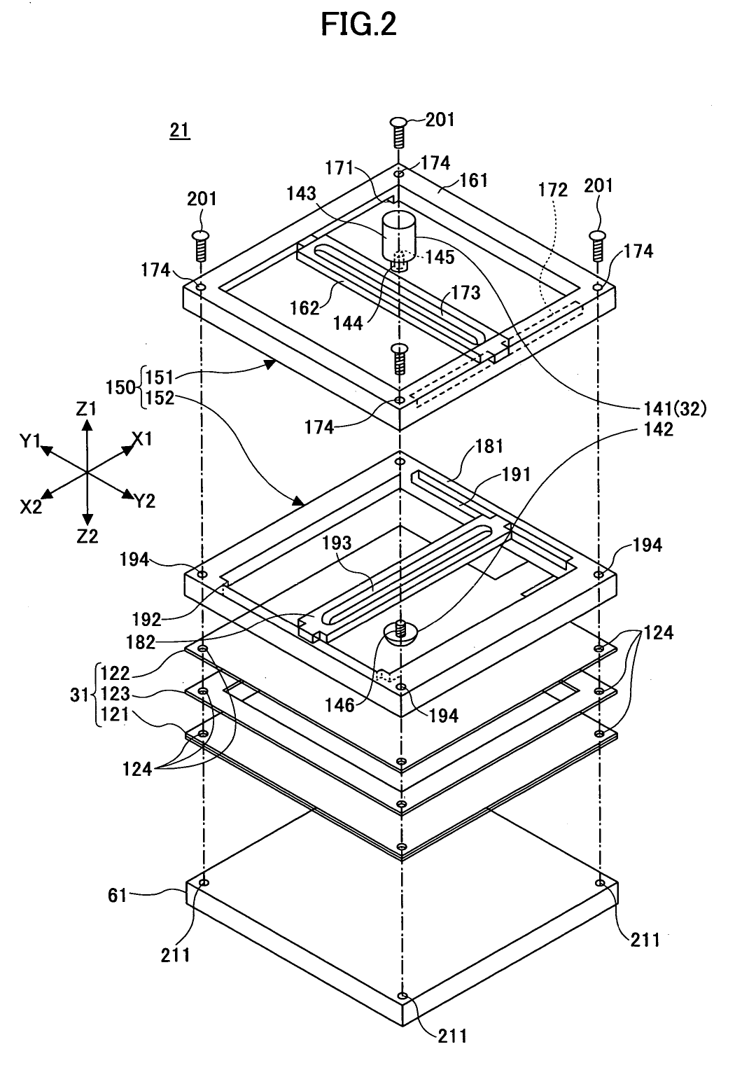

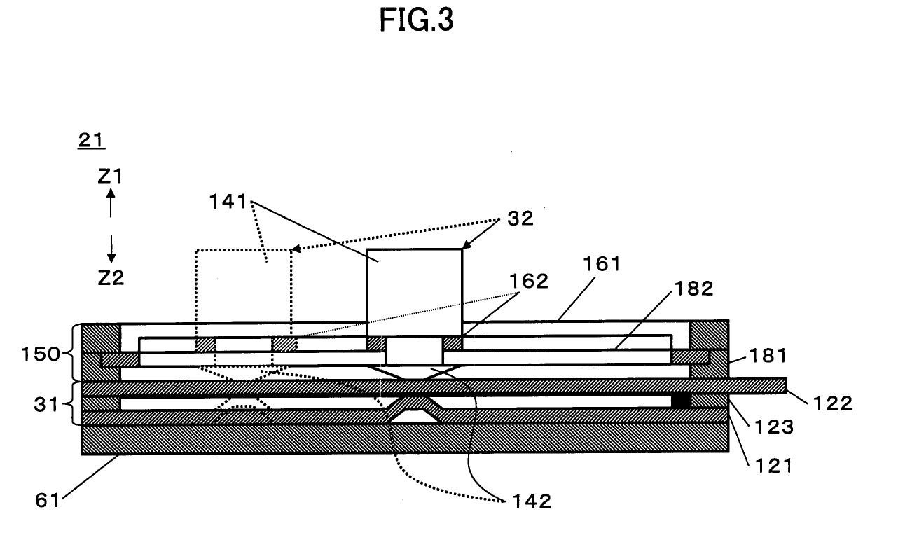

FIG. 2 is a perspective view showing the input apparatus 21 according to an embodiment of the present invention, and FIG. 3 is a cross-sectional view showing the input apparatus 21 according to an embodiment of the present invention.

The touch panel 31 is disposed on a base plate 61. The operation unit 32 is disposed at an upper part of the touch panel 31 in an arrow Z1 direction. In this embodiment of the present invention, a head part 142 which is disposed between the operation unit 32 and the touch panel 31 serves as the operation mechanism.

First, a structure of the touch panel 31 is described below.

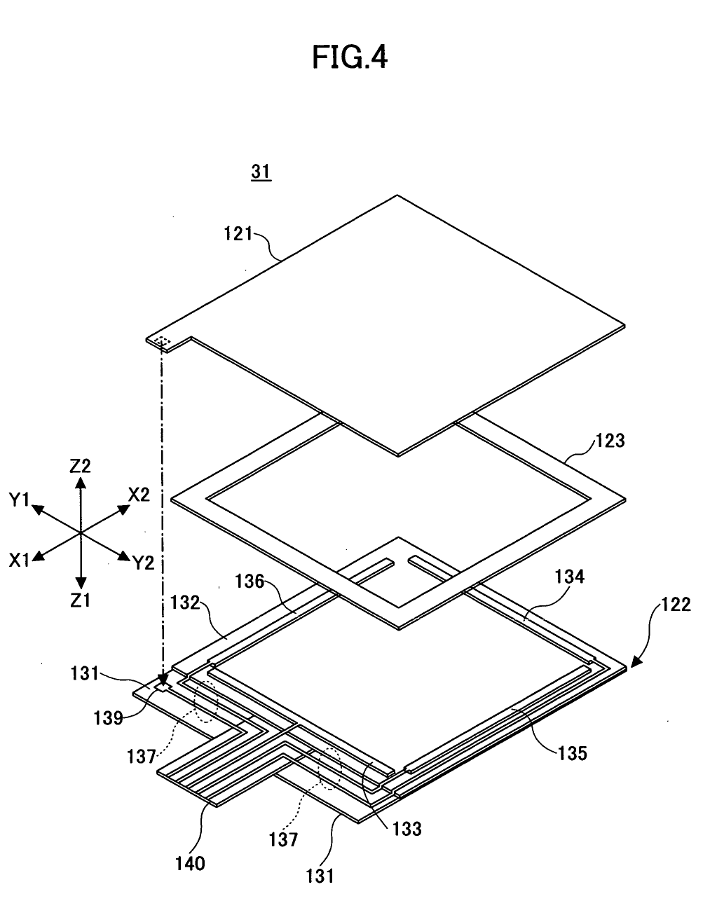

FIG. 4 is an exploded perspective view showing the touch panel 31 according to an embodiment of the present invention.

Here, the touch panel 31 is a resistant film type touch panel having a lower substrate 121 and an upper substrate 122 stacked with a spacer 123 interposed therebetween at its periphery.

The lower substrate 121 is formed of a flexible film-like magnetic material having a conductive property. The lower substrate 121 is connected to the upper substrate 122 in a manner described in greater detail below. Thereby, the lower substrate 121 can bend and attach to a magnet or the like.

The upper substrate 122 has a configuration in which a resistance film 132, electrodes 133-136, and a wiring pattern(s) 137 are stacked on a glass substrate 131. The resistance film 132 is made from, for example, indium tin oxide (ITO), and is formed substantially on the entire face of the glass substrate 131 facing the lower substrate 121, that is, substantially on the entire face of the glass substrate 131 facing toward arrow direction Z2. The electrode 133 is made from, for example, silver (Ag), and is formed on the resistance film 132 at an edge part thereof toward arrow direction X1 in a manner extending parallel to arrow direction Y1, Y2. The electrode 134 is made from, for example, silver (Ag), and is formed on the resistance film 132 at an edge part thereof toward arrow direction X2 in a manner extending parallel to arrow direction Y1, Y2.

The electrode 135 is made from, for example, silver (Ag), and is formed on the resistance film 132 at an edge part thereof toward arrow direction Y2 in a manner extending parallel to arrow direction X1, X2. The electrode 136 is made from, for example, silver (Ag), and is formed on the resistance film 132 at an edge part thereof toward arrow direction Y1 in a manner extending parallel to arrow directions X1, X2.

The wiring patterns 137 are formed on the resistance film 132 and/or the glass substrate 131 via an insulation layer, in which one end of the wiring patterns 137 is connected to one of the electrodes 133-136 and a connection pad 139, and the other end of the wiring patterns 137 is connected to one end of cable 140. The connection pad 139 is connected to the upper substrate 121. It is to be noted that the other end of cable 140 is connected to the circuit board 22.

Next, the operation unit 32 is described.

The operation unit 32 includes, for example, an operation knob 141. A moving mechanism 150 is in slidable engagement with the operation unit 32 by disposing the moving mechanism 150 between the operation knob 141 and the head part 142 and fastening the head part 142 to the operation knob 141.

The operation knob 141 includes a knob part 143 and an engagement part 144. The operation knob 141 is disposed toward arrow direction Z1 of the moving mechanism 150. The engagement part 144 is slidably engaged to the moving mechanism 150.

The moving mechanism 150 has a first moving mechanism part 151 and a second moving mechanism part 152.

The first moving mechanism part 151 includes a frame part 161 and a guide part 162. The frame part 161, having a rectangular shape, is provided with guiding grooves 171 and 172. The guiding grooves 171 and 172 are formed extending parallel to arrow directions X1, X2 at a lower inner peripheral part of the frame part 161 toward arrow direction Z2.

The guide part 162 is disposed between and in sliding engagement with the guide grooves 171, 172 in a direction parallel to arrow directions Y1, Y2. The guide part 162 is movable in arrow directions X1, X2 by having both of its ends guided by the guiding grooves 171, 172.

A guiding slot 173 is formed at a center portion of the guide member 162 along arrow directions Y1, Y2. The engagement part 144 of the operation knob 141 is slidably inserted in the guiding slot 173. The operation knob 141 is engaged to the guiding slot 173 in a movable manner towards arrow directions Y1 and Y2.

A second moving mechanism part 152 includes a frame part 181 and a guide part 182. The frame part 181 is provided with guiding grooves 191 and 192. The guiding grooves 191 and 192 are formed extending parallel to arrow directions Y1, Y2 at an upper inner peripheral part of the frame part 181 toward arrow direction Z1.

The guide part 182 is disposed between and in sliding engagement with the guide grooves 191, 192 in a direction parallel to arrow directions X1, X2. The guide part 182 is movable in arrow directions X1, X2 by having both of its ends guided by the guiding grooves 191, 192.

A guiding slot 193 is formed at a center portion of the guide member 182 along arrow directions X1, X2. The engagement part 144 of the operation knob 141 is slidably inserted in the guiding slot 193. The operation knob 141 is engaged to the guiding slot 193 in a movable manner towards directions X1 and X2.

The engagement part 144 of the operation knob 141 is inserted through the guiding slots 173 and 193 from direction Z1 to direction Z2. A thread hole 145 is formed in the engagement part 144. The head part 142 is formed with a screw part 146 corresponding to the thread hole 145 of the engagement part 144. The head part 142 is fixed to the operation knob 141 by having the screw part 146 screwed to the thread hole 145 of the engagement part 144.

The head part 142, which in the illustrated embodiment serves as the operation mechanism, is magnetized in arrow directions Z1, Z2 to form a permanent magnet. The head part 142 is formed with a substantially round shape, in which its end surface projecting toward arrow direction Z2 has a substantially rounded conical shape or a semi-spherical shape, for example.

By inserting the engagement part 144 of the operation knob 141 through the guiding slots 173, 193 and fastening the screw part 146 of the head part 142 through the threaded hole 145 of the engagement part 144, the operation unit 32 is engaged to the moving mechanism 150 in a movable manner in directions X1, X2, Y1, and Y2. Furthermore, the first and second moving mechanisms 151, 152 and the touch panel 31 are fixed to a base plate 61 by inserting screws 201 through the through-holes 174, 194, and 124 and fastening the screws 201 into respective thread holes 211 in the base plate 61.

Thus structured, the moving mechanism 150 guides the movement of the operation unit 32 in directions X1, X2, Y1, Y2 along an operation face (face facing toward direction Z1) of the touch panel 31. It is to be noted that since both the first and second moving mechanism parts 151 and 152 are employed for guiding the movement of the operation unit 32, the operation knob 141 can be moved smoothly.

The first and second moving mechanism parts 151, 152, and the touch panel 31 are fixed to the base plate 61 by threading the screw 201 into the thread hole 211 of the base plate 61 via the through-holes 174, 194, and 124. Thereby, the head part 142 contacts a side of the upper substrate 122 of the touch panel 31 facing toward direction Z1. As described above, the head part 142 is formed of a permanent magnet magnetized in directions Z1, Z2, and the lower substrate 121 of the touch panel 31 is formed of a flexible magnetic material. Therefore, when the head part 142 contacts the face of the upper substrate 122 facing toward direction Z1, the lower substrate 121 bends (projects) toward direction Z1 at a portion where the head part 142 is situated, as shown in FIG. 3. Accordingly, the operation mechanism according to this embodiment of the present invention is formed of the head part 142.

By the contact of the lower substrate 121 and the upper substrate 122, the touch panel 31 sends a detection signal(s) corresponding to the position of the contact via the cable 140 (FIG. 4).

In the circuit board 22, the detection signal is converted into digital data by the analog/digital converter 42. Then, the digital data is sent to the CPU 43. Then, the CPU 43 executes a detection process.

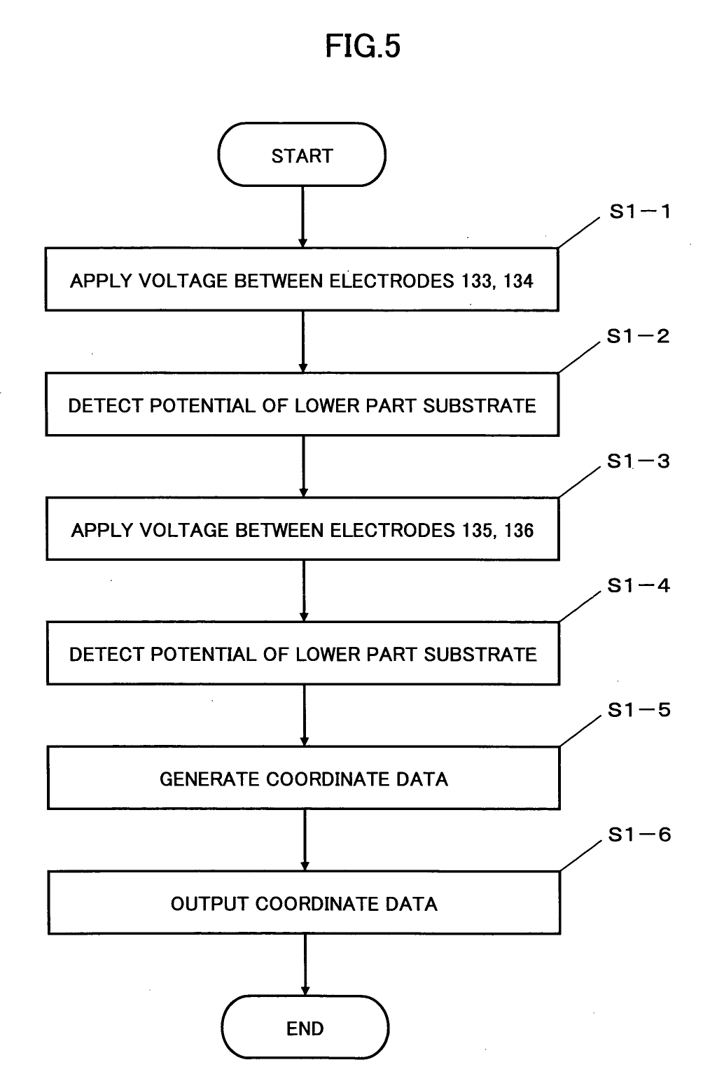

Next, the detection process executed by the CPU 43 is described with reference to FIG. 5.

First, the CPU 43 applies a predetermined voltage between electrodes 133 and 134 of the touch panel 31 (Step S1-1). Then, the CPU 43 detects the potential (electric potential) of the lower substrate 121 of the touch panel 31 (Step S1-2). This potential of the lower substrate 121 is the potential corresponding to the contact position of the lower substrate 121 with respect to the upper substrate 122 in the directions X1 and X2. In accordance with the detected potential, the coordinate in the directions X1 and X2 can be obtained.

Then, the CPU 43 applies a predetermined voltage between electrodes 135 and 136 (Step S1-3). Then, the CPU 43 detects the potential of the lower substrate 121 of the touch panel 31 (Step S1-4). This potential of the lower substrate 121 is the potential corresponding to the contact position of the lower substrate 121 with respect to the upper substrate 122 in the directions Y1 and Y2. In accordance with the detected potential, the coordinate in the directions Y1 and Y2 can be obtained.

Then, the CPU 43 generates coordinate data in accordance with a signal(s) of the detected potential for the directions X1, X2 obtained in Step S1-2 and a signal(s) of the detected potential for the directions Y1, Y2 obtained in Step S1-4 (Step S1-5). Then, the CPU 43 outputs the generated coordinate data (Step S1-6).

According to the first embodiment of the present invention, since the touch panel 31 is provided to the input apparatus 21 using the operation unit 32 as the executing input, the touch panel 31 can be formed into a thin size. Furthermore, with the operation mechanism, the contact position can be accurately detected. Furthermore, by forming the bottom side of the head part 162 into a curved face such as a spherical shape (round), the contact area can be reduced for enabling position to be detected more precisely.

Furthermore, since the moving mechanism 150 has a detachable structure, the touch panel 31 can be removed therefrom to be used as an ordinary touch panel. Therefore, owing to the detachable structure of the moving mechanism 150, the touch panel 31 can be used as a touch panel dedicated for the input apparatus 21 using the operation unit 32 when attached to the moving mechanism 150. On the other hand, the touch panel 31 can be used as an ordinary touch panel when detached from the moving mechanism 150.

Although an analog resistance film type touch panel is used as the touch panel 31 according to the embodiment of the present invention, a matrix resistance film type touch panel may alternatively be used. Furthermore, the touch panel 31 according to the embodiment of the present invention is not limited to a five-wire type touch panel, but other types, for example, a seven-wire type or an eight-wire type, may alternatively be employed. As will be appreciated, the touch panel 31 is not to be limited based on the type (method) of detection.

Although the lower substrate 121 of the touch panel 31 according to the embodiment of the present invention is formed of a flexible sheet-like magnetic material, a flexible magnetic sheet may alternatively be disposed under the lower substrate 121 of the touch panel for enabling the flexible magnetic sheet under the lower substrate 121 to bend the lower substrate of the touch panel when contact is made with the head part for executing position detection.

### Second Embodiment

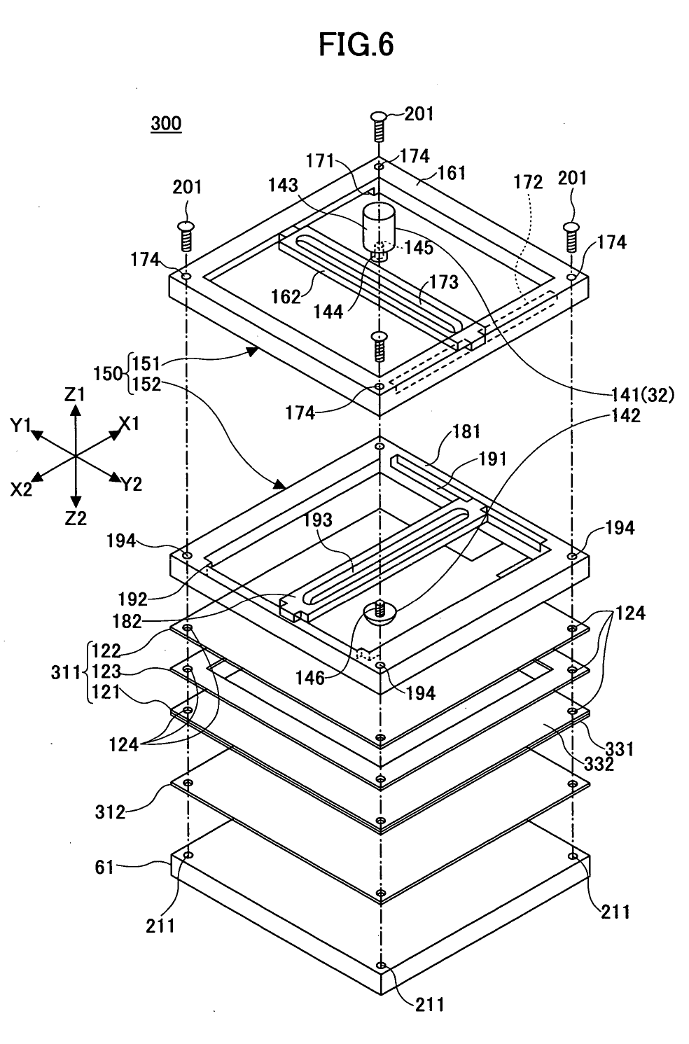

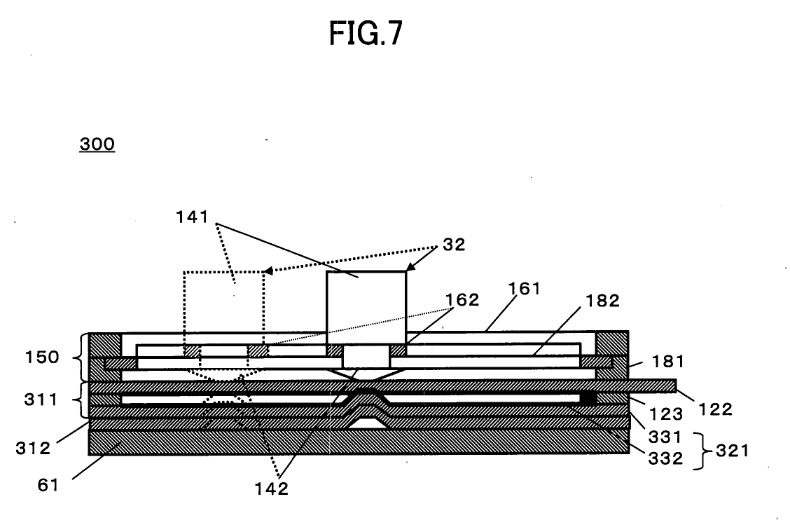

FIG. 6 is an exploded perspective view of an input apparatus 300 according to a second embodiment of the present invention. FIG. 7 is a cross-sectional view of the input apparatus 300 according to the second embodiment of the present invention. In these drawings, like components are denoted by like numerals as of FIGS. 2 and 3 in the first embodiment of the present invention, and will not be further explained.

The input apparatus 300 according to the second embodiment of the present invention includes a touch panel 311 and a flexible sheet-like magnetic material 312 and has a configuration which is different from the input apparatus 21 according to the first embodiment of the present invention. The touch panel 311 has a lower substrate 321 provided with a structure similar to that of a typical resistance film type touch panel. The lower substrate 321 includes a conductive film 332 formed on a resin sheet 331. The flexible magnetic sheet 312 is disposed between a base plate 61 and the touch panel 311.

In the input apparatus 300 according to the second embodiment of the present invention, a portion of the flexible magnetic sheet 312 is attracted to a head part 142 via the touch panel 311. Here, the portion of the flexible magnetic sheet 312 bends (projects), and urges the lower substrate 321 toward direction Z1, to thereby force the lower substrate 321 to contact the upper substrate 122.

In the operation mechanism 33 described in the first and second embodiments of the present invention, although a flexible magnetic sheet is provided as the lower substrate 121 or as the flexible magnetic sheet 312 disposed under the touch panel 311, other magnetic materials (magnetic members) may alternatively be employed for magnetic attraction to the head part 142 of the operation unit 32.

### Third Embodiment

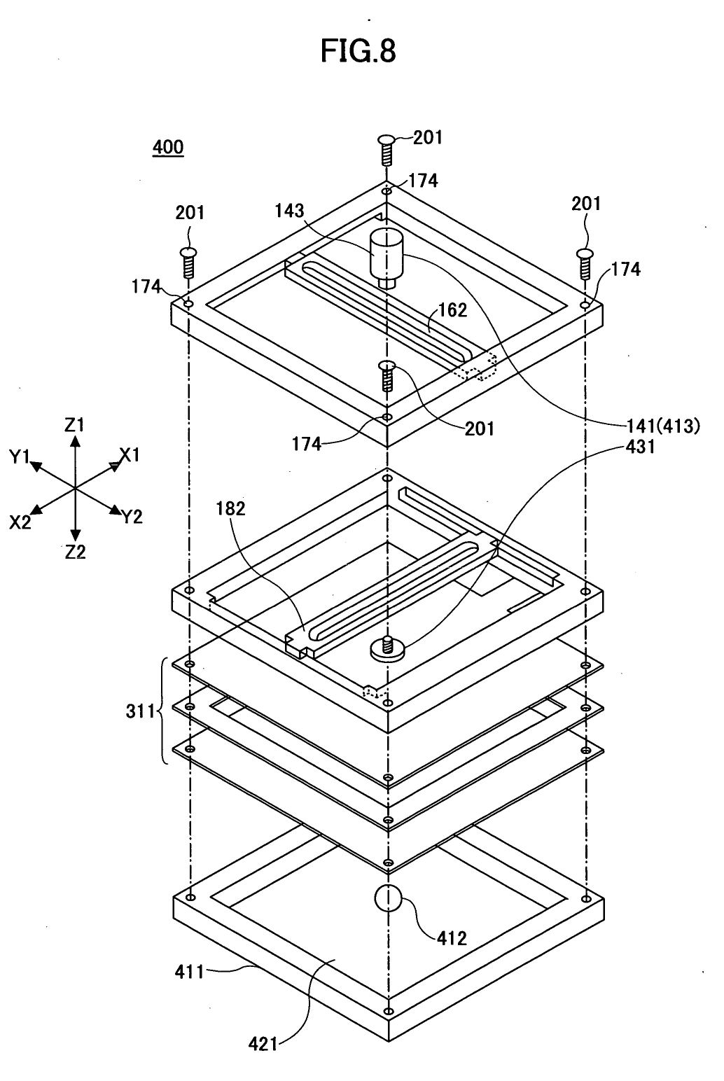

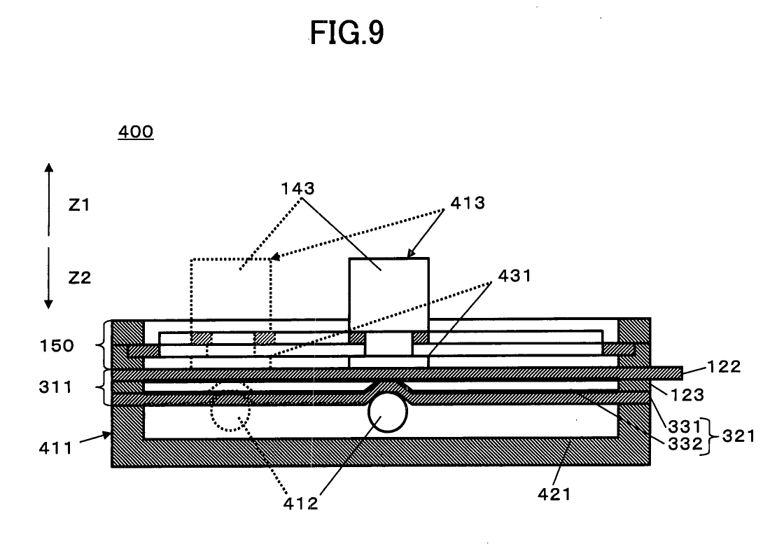

FIG. 8 is an exploded perspective view of an input apparatus 400 according to the third embodiment of the present invention. FIG. 9 is a cross-sectional view of the input apparatus 400 according to the third embodiment of the present invention. In these drawings, like components are denoted by like numerals as of FIGS. 2, 3, 6, and 7 in the first and second embodiments of the present invention, and will not be further explained.

The input apparatus 400 has a base plate 411 that is different from that of the input apparatus 21 in the first embodiment of the present invention.

As shown in the cross-sectional view in FIG. 9, the base plate 411 is formed with a recess part 421. A magnetic spherical member 412 is provided in the recess part 421 of the base plate 411. It is to be noted that the diameter of the magnetic spherical member 412 is substantially equal to the depth of the recess part 421 in the base plate 411.

Similar to the touch panel 311 of the second embodiment of the present invention, the lower substrate 321 includes the conductive film 332 formed on the resin sheet 331 (i.e. on a plane of the resin sheet facing the upper substrate 122). In the operation unit 413 according to the third embodiment of the present invention, the illustrated exemplary head part 431 has a bottom end plane (toward direction Z2) that is flat (FIG. 9).

With the input apparatus 400 according to the third embodiment of the present invention, the magnetic spherical member 412 is attracted to the head part 431 via the touch panel 311. Here, the magnetic spherical member 412 forces a portion of the lower substrate 321 to bend (project), to thereby enable the portion of the lower substrate 321 to contact the upper substrate 122. Furthermore, when the operation unit 413 is moved, the magnetic spherical member 412 correspondingly follows the movement of the operation unit 413. Here, since the magnetic spherical member 412 has a spherical shape, the magnetic spherical member 412 can rollingly move, thereby providing a smooth movement.

In the input apparatus 400 according to the third embodiment of the present invention, the magnetic spherical member 412 can be firmly attracted to the head part 431 by forming the bottom end plane (toward direction Z2) of the head part 431 as a flat plane. Furthermore, the contact area with respect to the touch panel 311 can be small by employing a magnetic spherical member 412 to be attracted to the head part 431. Thereby position detection can be executed with more precision.

### Fourth Embodiment

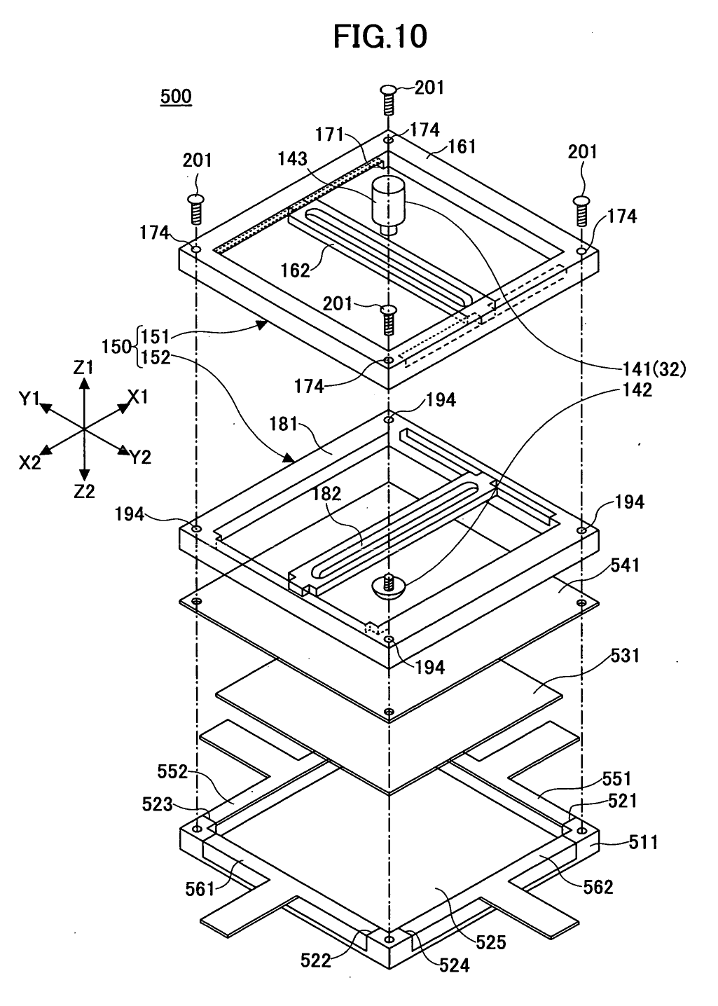

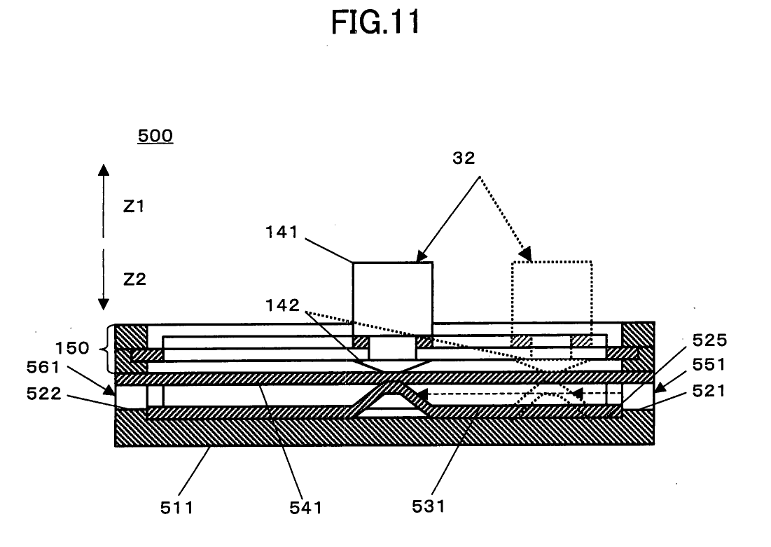

FIG. 10 is an exploded perspective view of an input apparatus 500 according to a fourth embodiment of the present invention. FIG. 11 is a cross-sectional view of the input apparatus 500 according to the fourth embodiment of the present invention. In these drawings, like components are denoted by like numerals as of FIGS. 2 and 3 in the first embodiment of the present invention, and will not be further explained.

In the input apparatus 500, an optical touch panel 541 is employed as the touch panel. As shown in the cross-sectional view in FIG. 11, a base plate 511 has a recess part 525. Here, each side of the recess part 525 is provided with notch parts 521-524. A flexible magnetic sheet 531 is installed in the recess part 525 of the base plate 511. It is to be noted that the flexible magnetic sheet 531 is formed with a shape which is substantially the same as that of the bottom face of the recess part 525 of the base plate 511. Furthermore, the touch panel 541 (dividing plane) is fixed to a top plane (plane facing direction Z1) of the base plate 511.

An illumination unit 551 is attached to the notch part 521 of the base plate 511. The illumination unit 551 has, for example, illumination elements arranged in directions Y1, Y2 for irradiating light toward an inner side (toward direction X2) of the recess part 525.

A light receiving unit 561 is attached to the notch part 522 of the base plate 511. The light receiving unit 561 has, for example, light receiving elements arranged in directions Y1, Y2 for detecting light from an inner side (from direction X1) of the recess part 525.

An illumination unit 552 is attached to the notch part 523 of the base plate 511. The illumination unit 552 has, for example, illumination elements arranged in directions X1, X2 for irradiating light toward an inner side (toward arrow direction Y2) of the recess part 525.

A light receiving unit 562 is attached to the notch part 524 of the base plate 511. The light receiving unit 562 has, for example, light receiving elements arranged in arrow directions X1, X2 for detecting light from an inner side (from arrow direction Y1) of the recess part 525.

As shown in FIG. 11, a portion of the flexible sheet-like magnetic material 531 is attracted to the head part 142 via the touch panel 541. The portion of the flexible sheet-like magnetic material 531 bends (projects) as the flexible sheet-like magnetic material 531 is attracted to the head part 142 via the touch panel 541. The light irradiated from the illumination units 551, 552 to the light receiving units 561, 562 is blocked at the projecting portion of the flexible sheet-like magnetic material 531. Accordingly, the position of the operation unit 32 can be detected by detecting the location where the light is blocked.

It is to be noted that although the flexible sheet-like magnetic material 531 is employed for the above-described position detection, other magnetic materials (magnetic members) may alternatively be employed for magnetic attraction towards to the head part 142.

### Fifth Embodiment

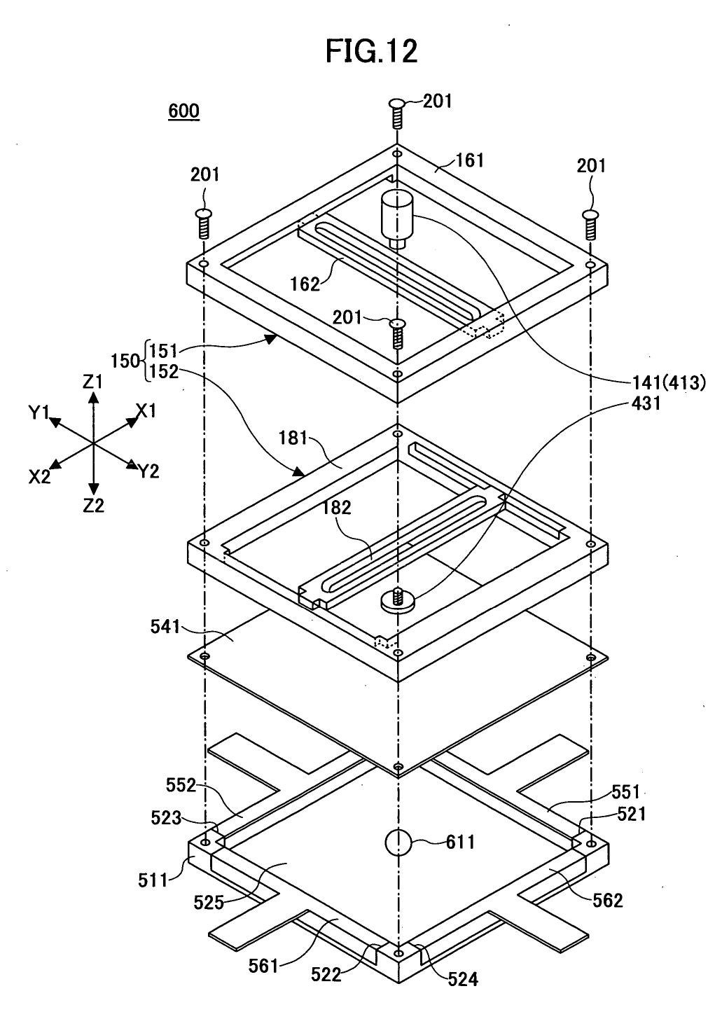

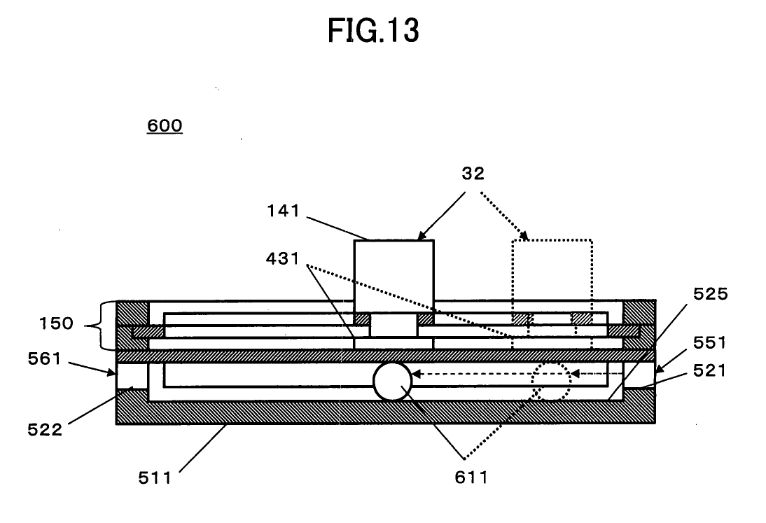

FIG. 12 is an exploded perspective view showing an input apparatus 600 according to a fifth embodiment of the present invention. FIG. 13 is a cross-sectional view showing an input apparatus 600 of the fifth embodiment of the present invention. In these drawings, like components are denoted by like numerals as of FIGS. 10 and 11 in the fourth embodiment of the present invention, and will not be further explained.

In the fifth embodiment, a magnetic spherical member(s) 611 is alternatively provided in the recess part 525 of the base plate 511. It is to be noted that the magnetic spherical member 611 has a diameter that is substantially equal to the depth of the recess part 525.

As shown in FIG. 13, the magnetic spherical member 611 is attracted to the head part 142 having the touch panel 541 situated therebetween. The light irradiated from the illumination units 551, 552 to the light receiving units 561, 562 is blocked at a position where the magnetic spherical member 611 is attracted. Accordingly, the position of the head part 142 can be detected by detecting the location where the light is blocked.

In the above-described embodiments, although a resistance film type touch panel and an optical type touch panel are employed as the touch panel, other types of touch panels may alternatively be employed (e.g. electrostatic capacity method touch panel, ultrasonic touch panel). Furthermore, although a glass substrate is employed as the upper substrate of the resistance film touch panel, a resin film may alternatively be employed.

Further, the present invention is not limited to these embodiments, but various variations and modifications may be made without departing from the scope of the present invention.

The present application is based on Japanese Priority Application No. 2004-216104 filed on Jul. 23, 2004, with the Japanese Patent Office, the entire contents of which are hereby incorporated by reference.

What is claimed is:

1. An input apparatus comprising:
a touch panel upper member for outputting a detection signal corresponding to an input position at which an input operation is executed;
a moveable lower member disposed with respect to the touch panel upper member;
an operation unit for executing the input operation; and
an operation mechanism which, in accordance with the input operation of the operation unit, is operable to urge the moveable lower member into contact with the touch panel upper member at the input position to thereby transmit the input position to the touch panel upper member and output the detection signal corresponding to the input position.

2. The input apparatus as claimed in claim 1, wherein the moveable lower member includes a flexible sheet lower member, and wherein the flexible sheet lower member is spaced from the touch panel upper member.

3. The input apparatus as claimed in claim 2, wherein the operation mechanism includes a head part, and wherein the head part and the flexible sheet lower member are disposed at opposite sides of the touch panel upper member.

4. The input apparatus as claimed in claim 3, wherein the operation mechanism is operable to urge the head part and the flexible sheet lower member towards one another to thereby urge the flexible sheet lower member into contact with the touch panel upper member.

5. The input apparatus as claimed in claim 4, wherein the urging is by magnetic attraction forces between the head part and the flexible sheet lower member.

6. The input apparatus as claimed in claim 3, wherein the head part is magnetized.

7. The input apparatus as claimed in claim 3, wherein the head part is disposed between the operation unit and the touch panel upper member.

8. The input apparatus as claimed in claim 3, wherein the head part is moveable by the operation unit along the touch panel upper member.

9. The input apparatus as claimed in claim 3, further comprising a moving mechanism for oscillatably guiding the operation unit along a surface of the touch panel upper member.

10. The input apparatus as claimed in claim 9, wherein the moving mechanism is detachably attached to the touch panel upper member.

11. The input apparatus as claimed in claim 3, wherein the head part has a bottom face formed as a round shape.

12. The input apparatus as claimed in claim 2, wherein the touch panel upper member and the flexible sheet lower member form a touch panel unit, and wherein the operation mechanism includes a head part and a moveable bending member disposed at opposite sides of the touch panel unit.

13. The input apparatus as claimed in claim 12, wherein the operation mechanism is operable to urge the head part and moveable bending member towards one another to thereby draw the flexible sheet lower member into contact with the touch panel upper member.

14. The input apparatus as claimed in claim 12, wherein the urging is by magnetic attraction forces between the head part and the moveable bending member.

15. The input apparatus as claimed in claim 12, wherein the movable bending member is spherical in shape.

16. The input apparatus as claimed in claim 12, wherein the head part is magnetized.

17. The input apparatus as claimed in claim 12, wherein the head part is disposed between the operation unit and the touch panel upper member.

18. The input apparatus as claimed in claim 12, wherein the head part is moveable by the operation unit along the touch panel upper member.

19. The input apparatus as claimed in claim 12, further comprising a moving mechanism for oscillatably guiding the operation unit along a surface of the touch panel upper member.

20. The input apparatus as claimed in claim 19, wherein the moving mechanism is detachably attached to the touch panel upper member.

21. The input apparatus as claimed in claim 12, wherein the head part has a bottom face formed as a round shape.

22. The input apparatus as claimed in claim 12, further comprising a base plate having a recess part on which the moveable bending member is disposed.

23. The input apparatus as claimed in claim 1, wherein the touch panel upper member and the moveable lower member form a resistance film touch panel.

24. The input apparatus as claimed in claim 1, wherein the touch panel upper member includes an optical touch panel.
